(19) United States
(12) Patent Application Publication
(10) Pub. No.: US 2011/0143684 A1
(43) Pub. Date: Jun. 16, 2011

(54) MANAGEMENT APPARATUS AND METHOD FOR CONTROLLING USER-OWNED COMMUNICATION DEVICE FOR OPERATION THEREOF AND PROVIDING EXTERNAL SERVICE THERETO

(75) Inventors: Hong Soog KIM, Daejeon (KR); Chan Yong LEE, Daejeon (KR); Eun Seon CHO, Daejeon (KR); Nam Hoon PARK, Daejeon (KR)

(73) Assignee: Electronics and Telecommunications Research Institute, Daejeon (KR)

(21) Appl. No.: 12/967,803

(22) Filed: Dec. 14, 2010

(30) Foreign Application Priority Data
Dec. 15, 2009 (KR) 10-2009-0124444

(51) Int. Cl. H04B 1/00

(52) U.S. Cl. 455/70

(57) ABSTRACT

Provided is a management apparatus and method for controlling a user-owned communication device for its operation according to a use specification and providing external service. An aspect of the present invention provides a management apparatus and method for operating, by a owner or an external user, a communication device according to a description of a use specification in which an operation plan, a right of access, a range of service provision, and the like are specified, in a use of the communication device owned as a property of a natural or juridical person, and the like.

### CROSS-REFERENCE TO RELATED APPLICATION

This application claims the benefit of Korean Patent Application No. 10-2009-0124444, filed on Dec. 15, 2009, in the Korean Intellectual Property Office, the disclosure of which is incorporated herein by reference.

### BACKGROUND

1. Field of the Invention

The present invention relates to a management apparatus and method for operating and controlling a communication device according to a description recorded in a use specification device, equipped with the use specification device in which an operation plan, a right of access, a range of service provision, and the like, are specified to be stored, in a use of the communication device owned as property.

2. Description of the Related Art

Conventionally, a wired and wireless communication device has been operated in a way that an operator as an owner rents out the wired and wireless communication device to a user. With the development in the wired and wireless Internet and a mobile communication technology, a communication device owned by an individual or a corporation (hereinafter, referred to as a user-owned communication device) such as a wireless Local Area Network (LAN) sharing unit, a femtocell base station, and the like, has been introduced. The user-owned communication device may be individually purchased, installed, and used by an owner such as a legal entity, and the like. In the case of a wireless LAN or the femtocell base station, the user-owned communication device may have a function of providing a service to an external user other than the owner (hereinafter, referred to as an external service) as well as utilizing for a use of the natural or juridical person (Hereinafter, which refers to an internal service). The user-owned communication device may be classified into a residential type, a corporation type, a hot spot type, and the like according to a range of use. The user-owned communication device may have a unique usage and service pattern based on the range of use.

In a conventional technology, in a case of communication equipment rented to the user and not owned by the user, a telecommunication operator owning the communication equipment may unilaterally control a way the communication equipment is used. However, in a case of the communication equipment owned by the legal entity other than the telecommunication operator, the telecommunication operator may lack a way of making a request for an external control or use, while the owner may directly control a power supply and a power shutoff, a range of service provision, and the like of the corresponding communication equipment.

In an internal use of the user-owned communication device, the owner may operate the device in a way of directly supplying the power to the device while the device is used, and directly shutting off the power of the device while the device is not used, or the owner may supply or shut off the power by being equipped with a timer.

However, in the internal use of the user-owned communication device, the owner may not provide an advanced and flexible control function such as a repetitive operation control for each week or for each month, a power on and off during a particular period of time such as a holiday, and the like, a control of service level, and the like. For example, the residential type user-owned communication device may be usually used during morning hours before a daily task or evening hours after the daily task during which family members are at home, and may seldom be used at bedtime. When the family members are at home all day during, for example, a weekend or holiday, the residential type device may be used all day except for bedtime. The corporation type communication device may seldom be used most hours except for office hours, and may not be used during a weekend or holiday. The corporation type communication device may have the usage pattern opposite to the usage pattern of the residential type communication device.

The user-owned communication device may consume a power and waste resources while on standby instead of providing a service for a long period of time. While the device may have resources for providing the service on standby, there may be a problem that the device may not be available for an external user in a case where the owner does not separately operate the device as an external service mode. When the device is operated as the external service mode so that the external user may use the device, a serviceability of the device may be disturbed based on the usage pattern of the external user since there may be no way of controlling a usage limit and usage time of the external user and a fixed setting function is provided.

### SUMMARY

An aspect of the present invention provides a management apparatus and method for controlling a user-owned communication device for its operation and providing external service.

Another aspect of the present invention also provides a management apparatus and method for operating and controlling a communication device according to a description of a use specification in which an operation plan, a right of access, a range of service provision, and the like are specified, in a use of the communication device owned as property of a legal entity, and the like.

According to an aspect of the present invention, there is provided a management apparatus to manage an operation of a communication device, the apparatus including an internal use specification storage unit to store an internal use specification corresponding to information for operating, depending on an intent of an owner, the communication device of the owner, and an operation control unit to read the internal use specification, and operate the communication device according to the read internal use specification.

According to another aspect of the present invention, there is provided a method of managing an operation of a communication device, the method including reading an internal use specification corresponding to information for operating, depending on an intent of an owner, the communication device of the owner, and operating the communication device according to the read internal use specification.

The present invention relates to a management apparatus and method for operating and controlling a communication device according to a description of a use specification in which an operation plan, a right of access, a range of service provision, and the like are specified, in a use of the communication device owned as a property of a legal entity, and the like. The management apparatus may minimize a standby power by limiting a usage level of the communication device or suspending the operation while the operation of the communication device is not required according to an internal use specification. The management apparatus may prevent a waste of communication resources and help extend a communication service coverage by providing an operation of the communication device to an external communication operator or user according to an external use specification.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a communication system including a management apparatus for controlling a user-owned communication device for its operation according to an embodiment of the present invention;

FIG. 2 is a diagram illustrating a configuration of an internal use specification;

FIG. 3 is a diagram illustrating a configuration of an external use specification;

FIG. 4 is a diagram illustrating a scheme of operating a communication device according to an internal use specification in a management apparatus; and

FIG. 5 is a diagram illustrating a scheme of operating a communication device according to an external use request in a management apparatus.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention relates to a management apparatus and method for operating and controlling a communication device according to a description of a use specification in which an operation plan, a right of access, a range of service provision, and the like are specified, in a use of the communication device owned as a property of a natural or juridical person, and the like.

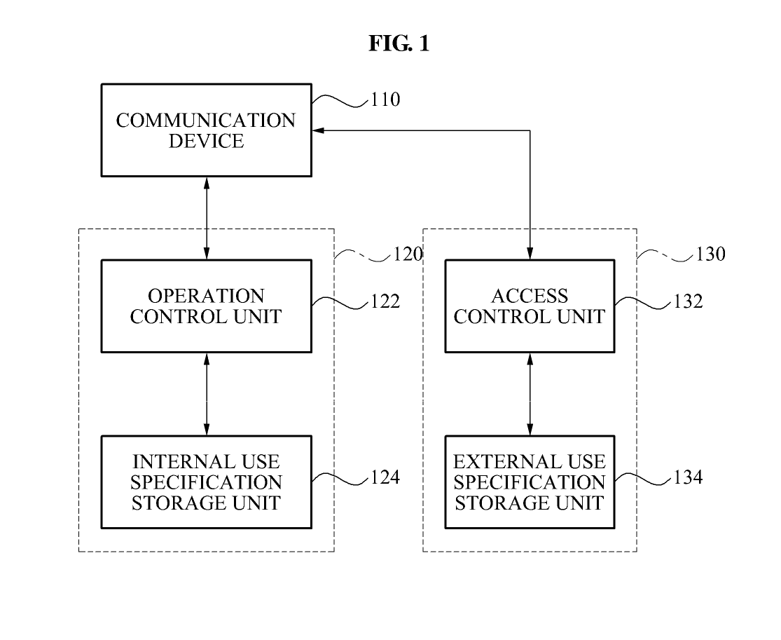

FIG. 1 is a diagram illustrating a configuration of a communication system including a management apparatus for controlling a user-owned communication device 110 for its operation according to an embodiment of the present invention. Referring to FIG. 1, the communication system may include the user-owned communication device 110, a management apparatus 120, and an external request apparatus 130.

The user-owned communication device 110 may correspond to a communication device owned as a property of a legal entity, and the like. The user-owned communication device 110 may include a home base station, a femto base station, and the like.

The management apparatus 120 may be an apparatus managing an operation of the communication device 110, and may be an apparatus controlled by an owner. The management apparatus 120 may include an operation control unit 122 and an internal use specification storage unit 124.

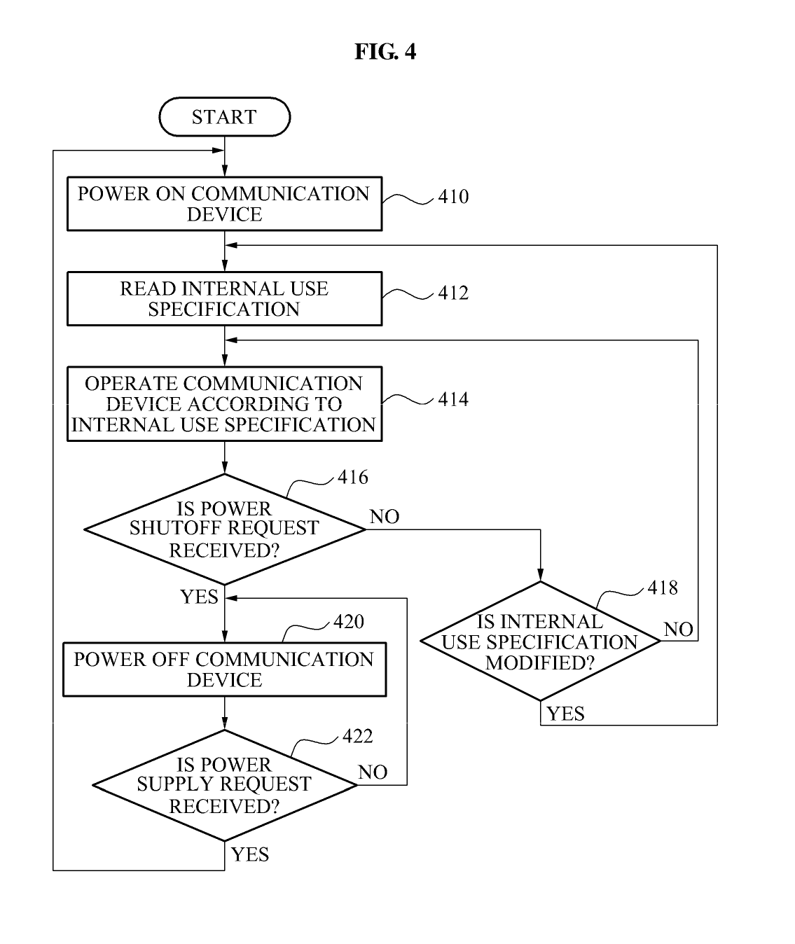

The operation control unit 122 may control the operation of the user-owned communication device 110 according to an internal use specification stored in the internal use specification storage unit 124. The operation control of the communication device 110 according to the internal use specification will be described with reference to FIG. 4.

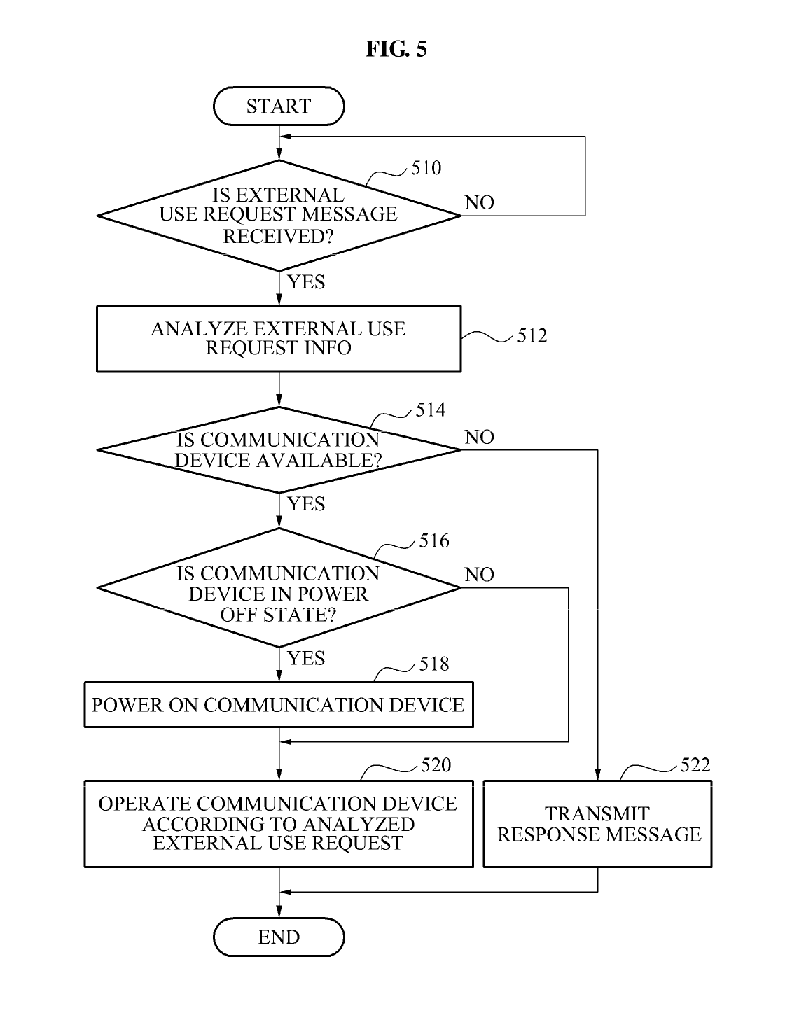

The operation control unit 122 may control the operation of the communication device 110 according to an external use request message received from the external request apparatus 130. The operation control of the communication device 110 according to the external use request will be described with reference to FIG. 5.

The operation control unit 122 may receive the external use request via the communication device 110. In a case where the communication device 110 is in a power off state, the power off state may correspond to a kind of a standby state in which the communication device 110 is driven by a standby power. Thus, the external use request message may be received while the communication device 110 is in the power off state.

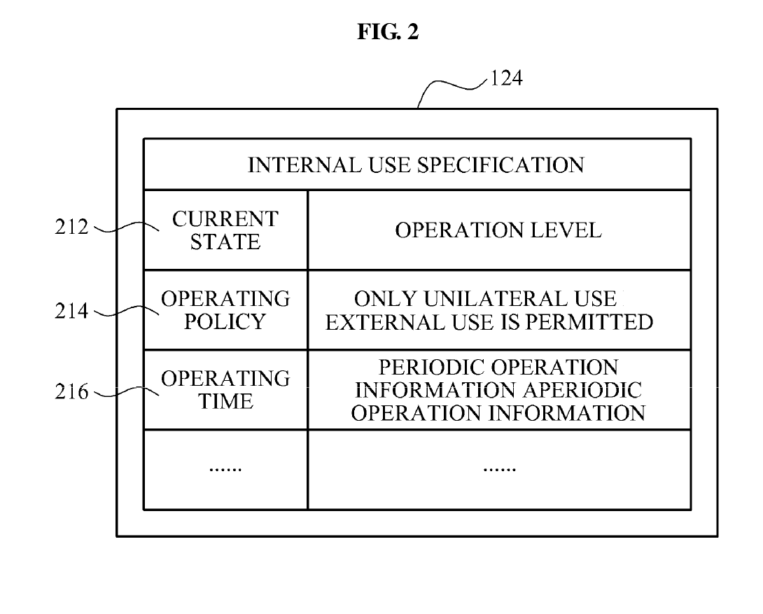

The internal use specification storage unit 124 may store the internal use specification in which requirements for controlling, depending on an intent of the owner, the operation of the user-owned communication device 110 are described. The internal use specification storage unit 124 is described with reference to FIG. 2.

FIG. 2 is a diagram illustrating a configuration of an internal use specification. Referring to FIG. 2, an internal use specification storage unit 124 may store information about a current state 212, an operating policy 214, an operating time 216, and the like.

In the current state 212, information about a current operation state of a communication device 110 may be maintained at predetermined intervals. The current state 212 may change depending on the operating policy 214, the operating time 216, and an external use specification.

The operating policy 214 may include information about whether the communication device 110 is unilaterally operated, not permitting an external use, about whether the external use is supported, about a support level in a case where the external use is supported, and the like. The support level of the external use may include information about whether it is possible to supply a power to the communication device 110, a degree of opening a service, and the like.

In the operating time 216, information about a period of time during which the communication device 110 is operated by the owner may be stored.

The operating time 216 may be periodically stored, for example, on a daily, weekly, or monthly basis. The operating time 216 may be aperiodically stored, for example, on a given day, at a given span of time, and the like.

Basically, the communication device 110 may not be operated by the owner during a span of time not designated by the operating time 216. However, in a case where an external use is permitted in the operating policy 214, and an access to the communication device 110 is permitted according to the external use specification, the communication device 110 may be operated by an external request apparatus 130 according to a request from the external request apparatus 130.

Information stored in an internal use specification storage unit 124 may be basic information for an embodiment. Thus, the information stored in the internal use specification storage unit 124 may not be limited to information records indicated in FIG. 2, and may be added, deleted, and modified, as necessary.

The external request apparatus 130 may be an apparatus for requesting an operation of the communication device 110 from outside of the communication device 110. The external request apparatus 130 may include an access control unit 132 and an external use specification storage unit 134.

The access control unit 132 may verify whether the communication device 110 is available outside of the communication device 110 by verifying an external use specification when an operation of the communication device 110 is requested from an external operator or an external user, and may transmit an external use request message to the communication device 110 when the external use is determined to be possible.

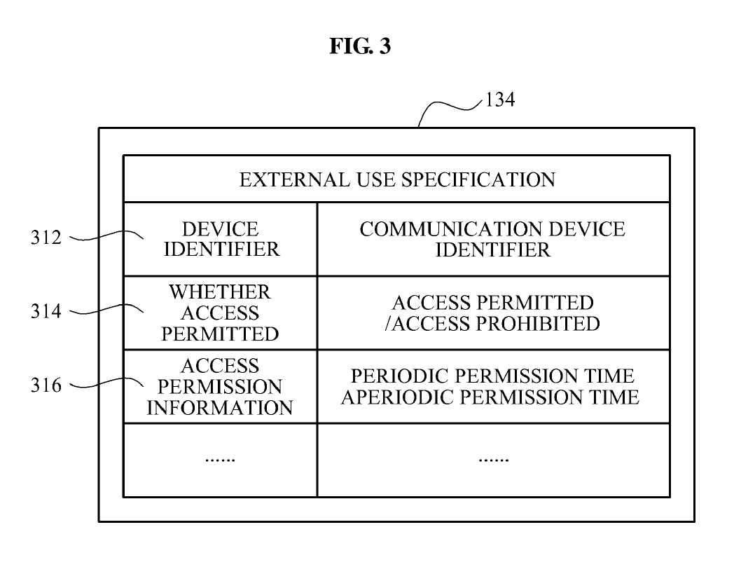

The external use specification storage unit 134 may store the external use specification corresponding to predetermined operation information for operating the communication device 110 by the external user. The external use specification may be information referred by the access control unit 132 when the outer operator or the user accesses the user-owned communication device 110. The external use specification storage unit 134 may be described with reference to FIG. 3.

FIG. 3 is a diagram illustrating a configuration of an external use specification. Referring to FIG. 3, an external use specification storage unit 134 may include a device identifier 312, whether an access is permitted 314, access permission information 316, and the like.

The device identifier 312 may be information identifying each communication device. The whether an access is permitted 314 may be information indicating whether an access for an external use is permitted. The access permission information 316 may be information indicating a period of time during which the access is possible when the access is permitted. The external use specification storage unit 134 may further include information indicating a cost for accessing the communication device 110 for the external use, location information, and the like.

Information stored in an external use specification storage unit 134 may be basic information for an embodiment. Thus, the information stored in the external use specification storage unit 134 may not be limited to information records indicated in FIG. 3, and may be added, deleted, and modified, as necessary.

Hereinafter, a management method for controlling the user-owned communication device configured according to an embodiment of the present invention as described above for its operation and providing an external service will be described with reference to figures.

FIG. 4 is a diagram illustrating a scheme of operating a communication device 110 according to an internal use specification in a management apparatus. The user-owned communication device 110 may maintain one of a power on state during which a power is supplied and a power off state during which the power is shut off.

Referring to FIG. 4, in operation 410, a management apparatus 120 may power on the communication device 110 by supplying the power to the communication device 110 when a power supply request is received from an owner or an external user. In operation 412, the management apparatus 120 may read an internal use specification stored in an internal use specification storage unit 124.

In operation 414, the management apparatus 120 may operate the communication device 110 according to the read internal use specification. Here, a current state 212 of the internal use specification stored in the internal use specification storage unit 124 may be updated at predetermined intervals.

In operation 416, the management apparatus 120 may verify whether the communication device 110 received a power shutoff request from the owner or the external user.

In operation 418, the management apparatus 120 may verify whether the internal use specification is modified by the owner or the external user when the power shutoff request is not received as a result of the verification in operation 416. When the internal use specification is modified as a result of the verification in operation 418, the management apparatus 120 may return to operation 412. When the internal use specification is not modified as a result of the verification in operation 418, the management apparatus 120 may return to operation 414.

In operation 420, the management apparatus 120 may power off the communication device 110 when the power shutoff request is received as a result of the verification in operation 416.

The management apparatus 120 may return to operation 410 when the power supply request of the communication device 110 is received from the owner or the external user in operation 422.

FIG. 5 is a diagram illustrating a scheme of operating a communication device 110 according to an external use request in a management apparatus 120.

Referring to FIG. 5, in operation 512, the management apparatus 120 may analyze external use request information from a received external use request message when the management apparatus 120 receives the external use request message from a external request apparatus 130 having permission to use the communication device 110 outside of the communication device 110.

In operation 514, the management apparatus 120 may verify whether the communication device 110 is available to an external user by verifying the external use request information and an internal use specification stored in an internal use specification storage unit 124.

In operation 516, the management apparatus 120 may verify whether the communication device 110 is in a power off state when the communication device 110 is available to the external user as a result of the verification in operation 514.

In operation 520, the management apparatus 120 may operate the communication device 110 according to the analyzed external use request when the communication device 110 is not in the power off state as a result of the verification in operation 516. Here, a current state 212 of the internal use specification stored in the internal use specification storage unit 124 may be updated at predetermined intervals.

In operation 518, the management apparatus 120 may power on the communication device 110 by supplying a power when the communication device 110 is in the power off state as a result of the verification in operation 516. After operation 518, the management apparatus 120 may proceed to operation 520.

In operation 522, the management apparatus 120 may transmit a communication device unavailability response message to the external request apparatus 130 when the communication device 110 is unavailable to the external user as a result of the verification in operation 514.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A management apparatus to manage an operation of a communication device, the apparatus comprising:
an internal use specification storage unit to store an internal use specification corresponding to information for operating, depending on an intent of an owner, the communication device of the owner; and
an operation control unit to read the internal use specification, and operate the communication device according to the read internal use specification.

2. The management apparatus of claim 1, wherein the operation control unit powers off the communication device by shutting off a power to the communication device when a power shutoff request is received from the owner or an external request device.

3. The management apparatus of claim 1, wherein the operation control unit powers on the communication device by supplying a power to the communication device when a power supply request is received from the owner or an external request device during a power off state of the communication device.

4. The management apparatus of claim 1, wherein the operation control unit stores a modified internal use specification in the internal use specification storage unit when the internal use specification is modified by the owner.

5. The management apparatus of claim 1, wherein the internal use specification comprises at least one of operation state information indicating a current operation state of the communication device, operating policy information both indicating whether the communication device is available by an external device and indicating a support level when the communication device is used outside of the communication device, and operating time information indicating a periodic span of time or an aperiodic span of time during which the communication device is operated by the owner.

6. The management apparatus of claim 1, wherein the operation control unit verifies external use request information included in an external use request message when the external use request message is received from an external request apparatus having permission to use the communication device outside of the communication device, and operates the communication device according to the external use request when the communication device is determined to be available outside of the communication device as a result of verification of the external use request information and the internal use specification.

7. The management apparatus of claim 6, wherein the operation control unit powers on the communication device by supplying a power in a case where the communication device is determined to be available outside of the communication device as a result of verification of the external use request information and the internal use specification, and the communication device is in a power off state, and the operation control unit operates the communication device according to the external use request.

8. The management apparatus of claim 6, wherein the external request apparatus comprises:
an external use specification storage unit to store an external use specification corresponding to predetermined operation information for operating the communication device by an external user; and
an access control unit to verify whether the communication device is available outside of the communication device by verifying the external use specification when an operation of the communication device is requested from the external user, and to transmit the external use request message to the communication device when the external use is determined to be possible.

9. The management apparatus of claim 8, wherein the external use specification comprises at least one of device identifier information for identifying the communication device, access permissibility information indicating whether an access for external use of the communication device is permitted, access permission information indicating a period of time the communication device is accessible for external use, cost information indicating a cost for accessing the communication device for the external use, and location information of the communication device.

10. A method of managing an operation of a communication device, the method comprising:
reading an internal use specification corresponding to information for operating, depending on an intent of an owner, the communication device of the owner; and
operating the communication device according to the read internal use specification.

11. The management method of claim 10, further comprising:
powering off the communication device by shutting off a power to the communication device when a power shutoff request is received from the owner or an external request device.

12. The management method of claim 10, further comprising:
powering on the communication device by supplying a power to the communication device when a power supply request is received from the owner or an external request device during a power off state of the communication device.

13. The management method of claim 10, further comprising:
storing a modified internal use specification when the internal use specification is modified by the owner.

14. The management method of claim 10, wherein the internal use specification comprises at least one of operation state information indicating a current operation state of the communication device, operating policy information both indicating whether the communication device is available by an external device and indicating a support level when the communication device is used outside of the communication device, and operating time information indicating a periodic time or an aperiodic time during which the communication device is operated by the owner.

15. The management method of claim 10, further comprising:
receiving an external use request message from an external request apparatus having permission to use the communication device outside of the communication device;
verifying external use request information included in the external use request message;
verifying whether the communication device is available outside of the communication device by verifying the external use request information and the internal use specification; and
operating the communication device according to the external use request when the communication device is determined to be available outside of the communication device.

16. The management method of claim 15, further comprising:
powering on the communication device by supplying a power in a case where the communication device is determined to be available outside of the communication device, the communication device is in a power off state, and
operating the communication device according to the external use request.

17. The management method of claim 15, further comprising:
determining whether the communication device is available outside of the communication device by verifying the external use specification corresponding to predetermined operation information for operating the communication device by an external user, when an operation of the communication device is requested from the external user; and
transmitting the external use request message to the communication device when the external use is determined to be possible as a result of the verification.

18. The management method of claim 17, wherein the external use specification comprises at least one of device identifier information for identifying the communication device, access permissibility information indicating whether an access for external use of the communication device is permitted, access permission information indicating a period of time the communication device is accessible for external use, cost information indicating a cost for accessing the communication device for the external use, and location information of the communication device.
